(19) United States
(12) Patent Application Publication
(10) Pub. No.: US 2014/0156503 A1
(43) Pub. Date: Jun. 5, 2014

(54) SYSTEMS AND METHODS FOR PROVIDING A CUSTOMIZABLE CREDIT REPORT

(71) Applicant: Experian Information Solutions, Inc., Costa Mesa, CA (US)

(72) Inventors: Patricia Cheryl Lassen, Orange, CA (US); Karthikeyan Reddy Aaravabhoomi, Irvine, CA (US)

(73) Assignee: Experian Information Solutions, Inc., Costa Mesa, CA (US)

(21) Appl. No.: 14/062,145

(22) Filed: Oct. 24, 2013

Related U.S. Application Data
(62) Division of application No. 13/692,809, filed on Dec. 3, 2012.

(51) Int. Cl. G06Q 40/02

(52) U.S. Cl. CPC G06Q 40/025
USPC 705/38

(57) ABSTRACT

Systems and methods are provided for enabling a user to select the types of data to be included in a credit reporting product, and for generating credit reports that are configured to be dynamically updated with additional data in response to user selections. In some embodiments, data selectable by a user for inclusion in a credit report or other product may include a variety of data not typically found on traditional credit reports.

### CROSS-REFERENCE TO RELATED APPLICATION

This application is a divisional of U.S. patent application Ser. No. 13/692,809, filed on Dec. 3, 2012, titled SYSTEMS AND METHODS FOR PROVIDING A CUSTOMIZABLE CREDIT REPORT, which is hereby incorporated by reference in its entirety herein.

### BACKGROUND OF THE DISCLOSURE

1. Field of the Disclosure

Among other things, this disclosure describes systems and methods for generating credit reports, including enabling a user to customize the types of data provided in a requested credit report.

2. Description of the Related Art

Credit data may be maintained by a credit bureau or similar entity. Credit data maintained by a given credit bureau may include account data for millions or even billions of customers, where each customer identified in the data may have one or more accounts. The credit data may be based on several sources of data which include existing trade data, new trade data, inquiries, public record data (for example, bankruptcy filings), change of address data, and so forth. A common type of credit data is “tradeline data” (or trade data). Tradeline data may be an entry by a credit grantor to a consumer's credit history which is maintained by a credit reporting agency. A tradeline describes the consumer's account status and activity and can include names of companies with which the applicant has accounts, dates the accounts were opened, credit limits, types of accounts, account balances, payment histories, and/or other data.

In the United States, for example, multiple credit bureaus are constantly receiving data from a large number of data sources, including, for example, banks, creditors and other account providers. The credit bureaus use the data, among other things, to provide credit reports, credit scores and other credit-related products or services to consumers and businesses. The systems of a given credit bureau are typically tailored to specific legal and business requirements of the country or region in which the bureau operates, as well as the needs of its customers, which may have evolved over a long period of time. A credit report for an individual or entity, as provided by a typical credit bureau, usually includes only a standard set of data types selected by the credit bureau for inclusion in credit reports.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1A illustrates one embodiment of an operating environment in which a product delivery system generates credit reports for delivery to a client system.

FIG. 1B illustrates one embodiment of a data flow for providing a credit report to a client system and for dynamically updating the credit report based on user selections.

FIG. 2 is a flow chart illustrating one embodiment of a method for enabling a user to define a credit reporting product by selecting data bands to be included in the product.

FIG. 3 is a flow chart illustrating one embodiment of a method for generating an electronic credit report and dynamically updating the generated report based on user selection of additional data bands.

FIG. 4 is an illustrative embodiment of an electronic credit report, generated by a product delivery system, which includes selectable options for dynamically updating the credit report with additional data.

FIG. 5 is an illustrative embodiment of an electronic credit report, generated by the product delivery system, which has been dynamically updated to include data associated with an additional data band selected by the user.

FIG. 6 includes illustrative graphical representations of credit report product code information and data band cost information.

FIG. 7 is an illustrative embodiment of a user interface generated by the product delivery system that enables a user to select data bands to be included in a credit reporting product.

FIG. 8 illustrates one embodiment of a system for generating electronic credit reports.

### DETAILED DESCRIPTION

Various embodiments of systems, methods, processes, and data structures will now be described with reference to the drawings. Variations to the systems, methods, processes, and data structures which represent other embodiments will also be described.

The systems of a typical credit bureau are not easily adaptable to comply with different business needs and/or legal regulations than those for which the systems are currently designed. Generally described, aspects of the present disclosure relate to systems and methods that enable a credit bureau or other entity that maintains credit data and/or other data to deliver credit reports and/or other products utilizing the credit data and/or other data in a manner that is adaptable and customizable by a client, such as a consumer or partner service. In some embodiments, aspects of the present disclosure enable a client to select from among a number of available data types, data fields, and/or groups of data (generally referred to herein as data bands) for inclusion in a credit report or other product. Other aspects of the disclosure relate to generating a credit report that includes selectable options within the credit report that enable a user viewing the credit report to select one or more additional data bands to be dynamically added to the report. While data bands are often used herein as an example of portions of a credit report or other credit product that may be dynamically added or removed from a product based on user selections, according to certain embodiments, it will be appreciated that any data types, data groups, graphs, scores, models or other modularized data components may be similarly added or removed in some embodiments.

According to some embodiments, the data used in generating credit reports may include data received and processed from a potentially large number of data suppliers or data sources. The data may include, in some embodiments, consumer data, business data, account history, ledger account data, financial statements, firmographics, public records, public agency data, alerts, insurance information, vehicle records, rental information, commercial/business data, microfinance data, property data, utility data, employment data and/or other types of data. As used herein, according to certain embodiments, data included in (or considered in generating) credit reports may include data not traditionally considered by a credit bureau, such as banking transaction data, credit card transaction data, online purchase information, utility data, social network data, and so forth. In some embodiments, data other than credit data may be tied directly or indirectly to a given individual or company in stored records, and may be optionally included or considered when generating credit reports, as described herein. As one example, if a given individual owns a car identified by a certain vehicle identification number or other identifier, data may be stored that associates insurance information, purchase or sale data, and/or repair data for the given vehicle with the individual's records. The stored data considered in generating credit reports and/or other products described herein may have been received, processed and stored in a variety of ways, including by the systems and methods disclosed in related co-owned and co-pending U.S. patent application Ser. No. 13/546,965, entitled “SYSTEMS AND METHODS FOR LARGE-SCALE CREDIT DATA PROCESSING,” filed Jul. 11, 2012, which is incorporated herein by reference in its entirety.

Aspects of the disclosure, according to one embodiment, relate to a computer-implemented method for generating a customizable credit report. The method may include generating a user interface for display that includes one or more selectable options configured to enable a user to define a credit reporting product specification that identifies data to be included in at least one credit report. The one or more selectable options may include a number of data bands, where one or more of the data bands are selectable by the user for inclusion in the at least one credit report defined by the credit reporting product specification. The method may further include receiving a user selection of at least one of the data bands, where the user selection indicates that credit data associated with the at least one data band should be included in credit reports generated based on the credit reporting product specification. The credit reporting product specification defined by the user may then be stored in an electronic data store. Based at least in part on the credit reporting product specification defined by the user, at least one credit report for one or more individuals may then be generated at least in part by retrieving credit data associated with the one or more individuals, where the retrieved credit data may include credit data associated with the at least one data band selected by the user.

Other aspects of the disclosure, according to one embodiment, relate to a credit reporting system that may include a database configured to store a plurality of records that include credit data associated with each of a plurality of data bands. The credit reporting system may further include a credit report generation system that includes a request module and a report update module. The request module may be configured to receive a credit report request, where the received credit report request may include information identifying an individual for which a credit report should be generated. The request module may further be configured to generate an electronic credit report for the individual based at least in part on credit data retrieved from the database. The generated electronic credit report may include credit data associated with a first subset of data bands, and further include one or more selectable options that each identify an additional data band other than the first subset of data bands, where credit data associated with the additional data band is not included in the generated electronic credit report. The report update module may be configured to receive a user selection of at least one of the selectable options identifying an additional data band. The report update module may be further configured to retrieve, based at least in part on the received user selection, additional credit data from the database, where the additional credit data is associated with the additional data band identified in the selected at least one selectable option. The report update module may be further configured to dynamically update the generated electronic credit report to include the retrieved additional credit data.

Other aspects of the disclosure, according to one embodiment, relate to a computer-implemented method for providing a credit report. The method may include receiving a credit report request, where the received credit report request may include information identifying an individual for which a credit report should be generated. The method may further include generating an electronic credit report for the individual, where the generated electronic credit report may include credit data associated with a first subset of data bands. The generated electronic credit report may further include one or more selectable options that each identify an additional data band other than the first subset of data bands, where credit data associated with the additional data band is not included in the generated electronic credit report. The method may further include receiving a user selection of at least one of the selectable options identifying an additional data band, and dynamically updating the generated electronic credit report to include additional credit data associated with the additional data band identified in the selected at least one selectable option.

Other aspects of the disclosure, according to one embodiment, relate to a credit reporting system that includes a database configured to store a plurality of records that include credit data associated with each of a plurality of data bands. The credit reporting system may further include a credit report generation system that may include a product specification module and a request module. The product specification module may be configured to generate a user interface for display that includes one or more selectable options configured to enable a user to define a credit reporting product specification that identifies at least a portion of data to be included in at least one credit report. The one or more selectable options may include a plurality of data bands, where one or more of the plurality of data bands may be selectable by the user for inclusion in the at least one credit report defined by the credit reporting product specification. The product specification module may be further configured to receive a user selection of at least one of the plurality of data bands, where the user selection indicates that credit data associated with the at least one data band should be included in credit reports generated based on the credit reporting product specification. The product specification module may be further configured to store, in an electronic data store, the credit reporting product specification defined by the user. The request module may be configured to retrieve the credit reporting product specification stored by the product specification module. The request module may be further configured to generate at least one credit report for one or more individuals. The credit report may be generated at least in part by retrieving credit data associated with the one or more individuals from the credit database, where the retrieved credit data includes credit data associated with the at least one data band selected by the user

### Example Credit Reporting Environment and Data Flow

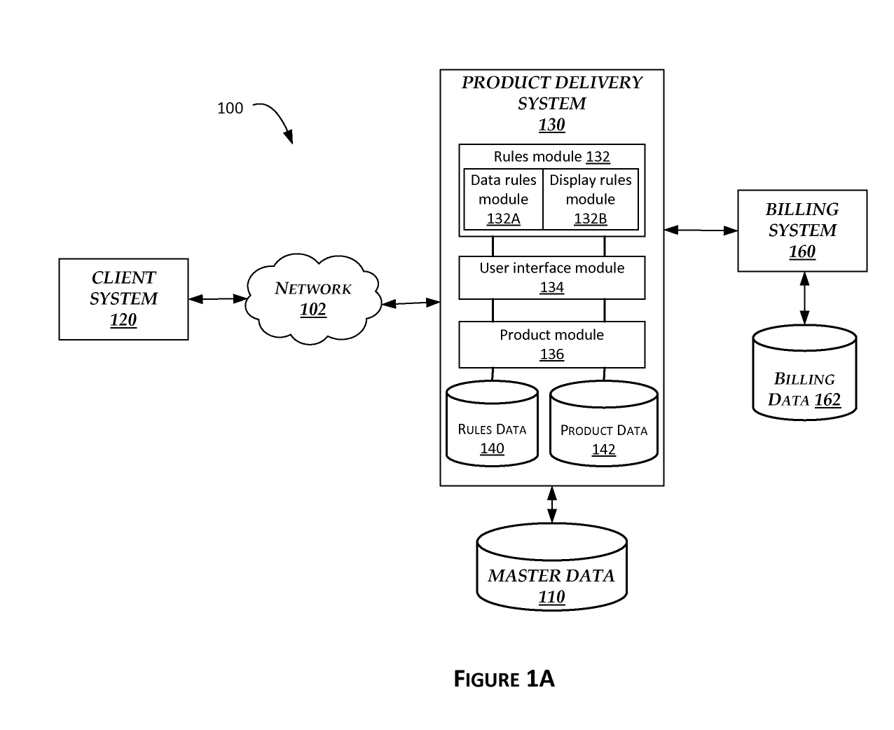

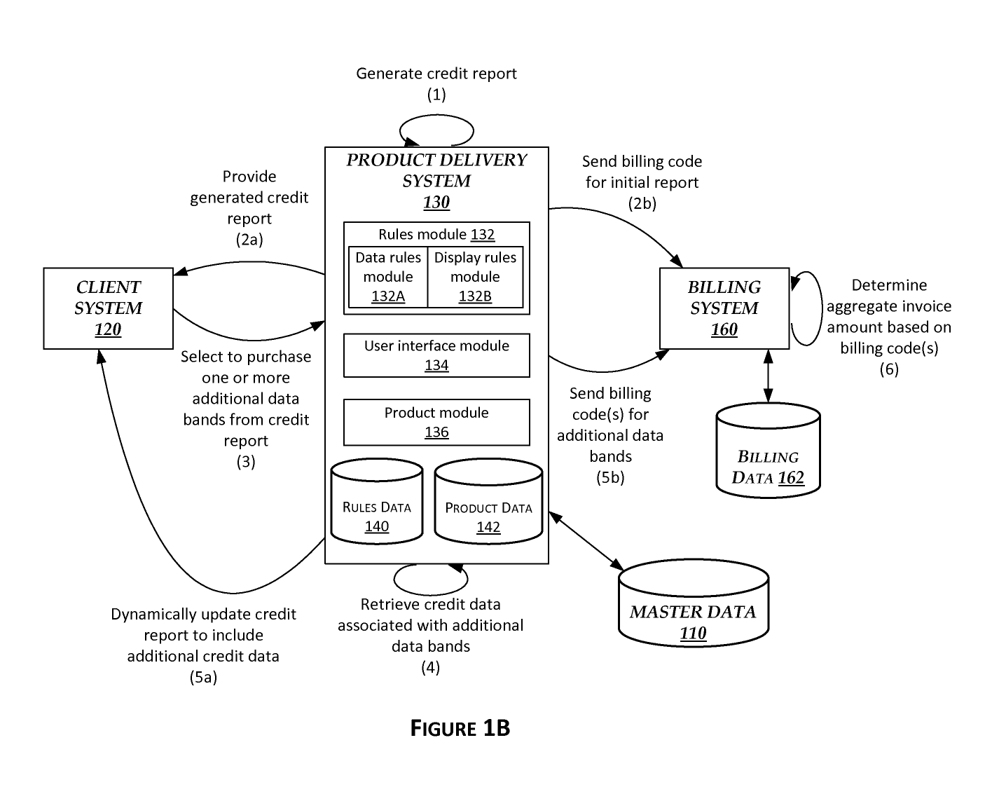

FIG. 1A illustrates one embodiment of an illustrative operating environment 100 for maintaining credit data and other data received from a variety of data sources and providing credit reports and other credit-related products to clients and partners. As illustrated, the illustrative operating environment 100 includes a product delivery system 130, master data store 110 and billing system 160, which may be in communication with each other via a wired or wireless communications link, and/or via a communication network, such as the Internet. The client system 120 may be in communication with the product delivery system 130 via a communications network 102, such as the Internet or other communications link.

In certain embodiments, the product delivery system 130, master data store 110 and billing system 160 may be collectively operated by a credit bureau or similar entity in order to receive, process, maintain and analyze credit data and other types of data relevant to consumers and/or businesses, including generating products, such as credit reports and credit scores, based on the processed data. The components illustrated in FIG. 1A may each be configurable based on particular needs of a specific operator. In some embodiments, each system and/or module illustrated in illustrative operating environment 100 may be configured to implement certain features, such that a given component, system and/or module may be swapped with a replaced or modified component, system or module without affecting performance of the operating environment as a whole or requiring changes to the other components, systems or modules. The various components of illustrative operating environment 100 are described in more detail below.

Master Data Store

In one embodiment, the master data store 110, which may be managed by the product delivery system 130 or by a master data system (not illustrated), generally stores processed data in a form that is accessible for generation of credit reports, credit scores and/or other products that utilize the stored data. In some embodiments, the processed data stored in master data store 110 may include hundreds of millions of records, including credit data and/or other data associated with individuals and/or businesses. The data stored in master data store 110 may be continuously updated with data received and processed from a variety of data sources or data suppliers. In some embodiments, the product delivery system 130 may access data stored in the master data store 110 directly. In other embodiments, the product delivery system 130 and/or other systems requesting access to data stored in master data store 110 may do so only through requests received by modules of a master data system (not illustrated) that controls access to the stored data.

Product Delivery System

In one embodiment, the product delivery system 130 may enable users, such as a consumer utilizing client system 120, to define custom products, such as credit reports, that utilize the data stored in master data store 110. Based on product specifications for a given consumer or commercial product, and considering rules maintained by the product delivery system, the product delivery system may generate a product and deliver the generated product to a consumer. As will be discussed in more detail below, users may define their own product specifications, in some embodiments, by selecting from among a number of available data bands. The credit reports or other products delivered by the product delivery system 130 may be configured to be dynamically updated with additional data from the product delivery system 130 upon user selection of additional available data bands identified in the report. In some embodiments, the product delivery system may enable concurrent access by a large number of clients and may be scalable based on business needs of a given credit bureau or other operator. A user or client may be an individual accessing their own credit report, a representative of a company accessing the company's credit report, as well as a representative of a company accessing the credit report of one or more other individuals or companies. For example, a user may represent a financial institution pulling credit reports for a group of 5000 individuals or 250 companies.

As illustrated in FIG. 1A, the product delivery system 130 includes a rules module 132, which includes data rules module 132A and display rules module 132B. The rules module 132 may retrieve and consider rules data stored in rules data store 140 when generating products, such as credit reports, and when responding to inquiries from users. Data rules may generally define which data types, data fields, and/or groups of data (also referred to as data bands) are available to potentially be accessed or included in a product, such as a credit report, as well as what data types, data fields, and/or data bands are required or standard. The display rules may generally define which of those potentially available data types, data fields, and/or data bands are accessible for display with respect to a specific account, specific product, specific country or region, and/or specific user, as well as what data types, data fields, and/or data bands are required. The display rules may be set at the time of an inquiry by a user, may be set in advance across an account (such as for all of a bank's users), or may be set in advance for a particular user or group of users (such as a bank user that falls into a specific customer subset). Data rules and/or display rules stored in rules data store 140 may include underlying regulatory or compliance rules (such as legal requirement regarding data fields that must be included when providing credit data in a given region), account-level rules and/or user-level rules. For example, according to one embodiment, product-specific data for a given product defined at the user level must comply with rules for the user, which must comply with the rules for the account associated with the user, which in turn must comply with regulatory and compliance rules.

As an example according to one embodiment, the rules module 132 may provide access to fifty different data types, forty five of which may each be selected by a user as either on or off for a specific product, while five may be required data types. A user may define a given product by selecting at least a subset of the optional available data types via one or more user interfaces generated by the user interface module 134. The user interface module 134 may communicate with the rules module 132 in order to determine the available data and/or required data for a specific region, account or user. The user interface module 134 may additionally communicate with the product module 136 in order to determine available product options such as display formats, delivery considerations, and so forth. The product data 142 may store product specification information, including account-specific products, predefined products (such as a credit report template), one or more previously defined report formats, campaign templates, common credit inquiries, and so forth.

In some embodiments, the product delivery system 130 may maintain a high level of data granularity, such that products may be defined with reference to specific data bands, data types, data fields, or other discrete portions of stored data records. Each data type or data band may be managed at least in part based on metadata associated with the data. For example, personal data, employment data and vehicle data associated with a given individual may be grouped into data bands based on metadata stored in association with the data. Similarly, different data types within a given data band may be independently managed based on metadata.

Billing System

In some embodiments, the financial cost billed to a user for a product generated and delivered to the consumer (or for additional data bands delivered to a consumer after initial product delivery) may be determined by one or more modules of the billing system 160. The financial cost may be determined, for example, based at least in part on information provided to the billing system 160 by the product module 136 regarding specific data bands or data types provided to the user as part of the report, such as product codes associated with specific reports, data bands or other modular portions of a report. The billing system may access stored billing data 162 when calculating monetary costs for a report, debiting an account, charging an account, and/or generating an invoice. The billing data 162 may include, in some embodiments, information associating each available data band with a product code and billing cost, if any.

Example Data Flow

FIG. 1B illustrates one embodiment of an overall data flow of illustrative operating environment 100, in which a user selects data bands to be included in or added to a credit report. The illustrated data flow may occur in response to a user of client system 120 requesting a credit report from the product delivery system 130 (initial request not illustrated in FIG. 1B). The product delivery system 130 may generate a credit report according to the user's request, such as by the product module 136 accessing credit data stored in master data store 110. The credit report product may be defined, in some embodiments, by a set of rules associated with the user and/or a region, and/or with reference to a product specification that is either previously stored or defined by the user. The master data store may provide the product delivery system with credit data and/or other data relevant to the request. For example, if the product is a credit report for a particular individual, the product delivery system may retrieve the individual's credit data associated with particular bands of data, as specified by a product definition or specification for the given credit reporting format stored in association with the product delivery system and/or generated in part based on data bands selected by the user.

When initially requesting the credit report, for example, a user may be presented with one or more user interfaces generated by the product delivery system 130 that enable the user to select data fields, data bands or portions of data that the user would like to be included in a custom credit reporting product, subject to constraints of rules data stored in rules data store 140. In some embodiments, the user interface provides the user with information on the pre-selected data fields, data bands, or portions of data that have already been selected based on regulatory constraints and/or customer settings. The user interface may also indicate additional data fields, data bands or portions of data that the user can add to the product (as discussed in more detail below) and/or pre-selected data fields, data bands, or portions of data that the user can remove from the custom product. Examples of predefined and/or customizable products may include, in some embodiments, consumer reports, commercial reports, public record reports, insurance reports, and/or some combination of elements typically included across different report types.

In some embodiments, when generating the credit report, the product delivery system 130 may retrieve rules associated with an account for which the product is to be generated. The rules may be retrieved, for example, from rules data store 140. Rules considered by the product delivery system in generating products may include, for example, an indication of which data types, data fields, and/or groups of data (also referred to as data bands) are available to potentially be accessed or included in a product, as well as what data types, data fields, and/or data bands are required based on regulatory or legal requirements. For example, a given country or region may require that a photograph of a property is included with any product that lists real estate information, while other regions may not have such a requirement, or may even prohibit inclusion of such photographs in certain types of credit products.

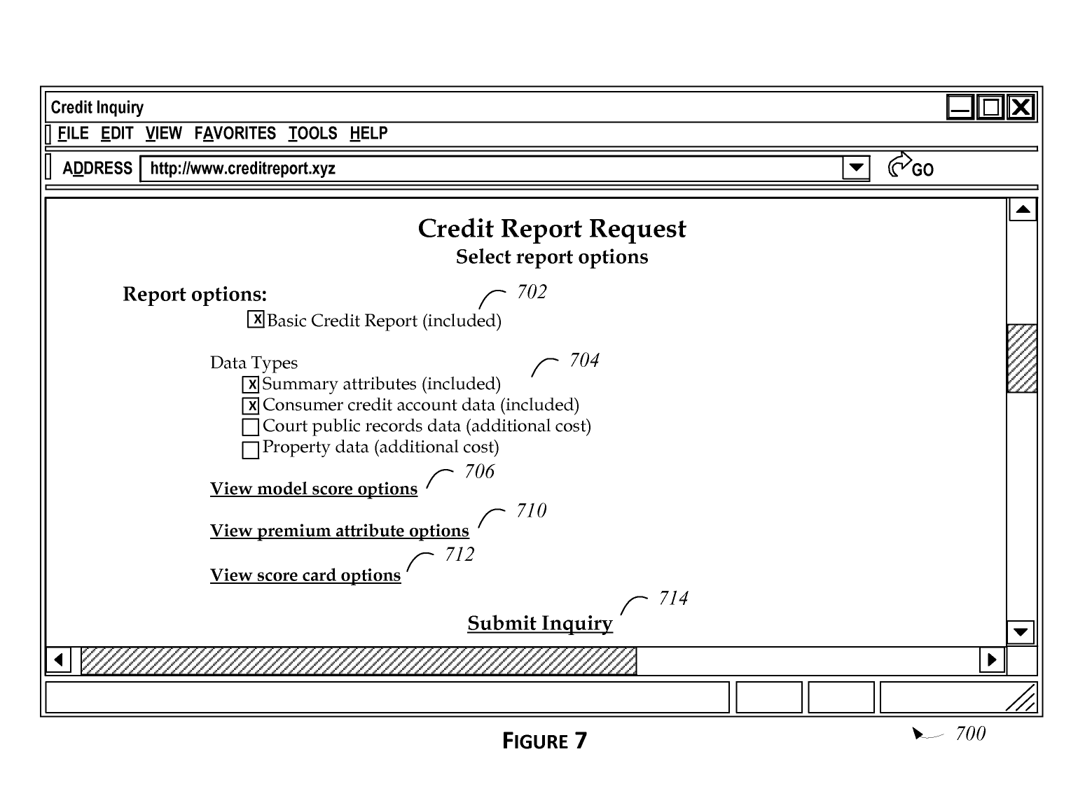

In some embodiments, when generating the credit report, the product delivery system 130 retrieves product specification information identifying a subset of the credit data objects (such as by identifying specific data bands) relevant to the product. For example, the product specification may define the data bands to be retrieved from the master data store 110 and included in the generated product. In some situations, such as when a predefined product is being generated, the product specification information may be retrieved from product data store 142. The retrieved product specification may include an indication of which data bands should have data included in the report, and which data bands should be included as selectable upgrade options from within the credit report or other product. In other instances, the product delivery system 130 may generate one or more user interfaces prior to the user's initial inquiry from which a user may select individual data fields or data bands to include in the credit report or other product, as discussed below with reference to FIG. 7. If the product specification indicates that only certain selected data bands are desired by the client, the product delivery system may verify that the request complies with applicable regulatory rules, account-level rules and/or user-level rules.

The credit report may be generated, in one embodiment, by arranging the received data in a report in accordance with the product specification information and a reporting format associated with the product and/or the account. In other embodiments, depending on the data bands or data types selected for inclusion in the report, the product delivery system may perform additional data analysis with respect to the received data, such as by applying one or more formulas to determine additional data to include in the product or by generating a chart or graph associated with the data.

As illustrated, the generated credit report may then be delivered to the client system 120 to be viewed by the user that requested the report. As will be appreciated, the credit report may be provided in a variety of forms, depending on the embodiment, including by email, by enabling a user to log in to a secure account using a username and password, via a web portal or other user interface, via an application programming interface (“API”), and/or via an application provided by the operator of the product delivery system 130 or a partner system. In association with the delivery of the credit report to the client system 120, in the illustrated embodiment, the product delivery system 130 may send billing code information for the initial report to the billing system 160. The billing code information may include, for example, information identifying the data bands or data types included in the credit report and/or information identifying a format or type of the credit report provided. The billing code information may be used by the billing system 160 to determine a cost for the report based at least in part on cost data stored in billing data store 162, discussed in more detail below.

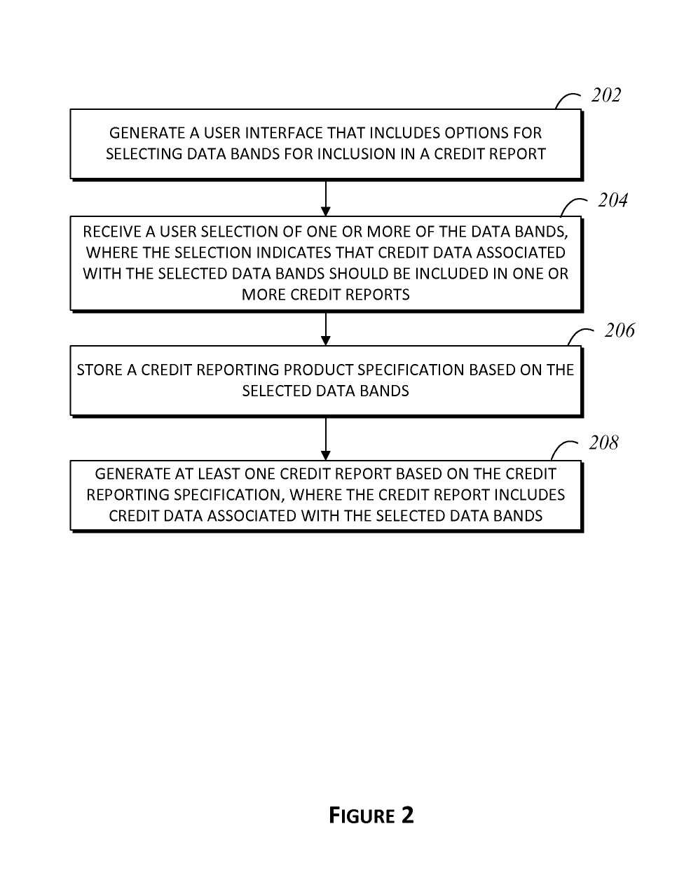

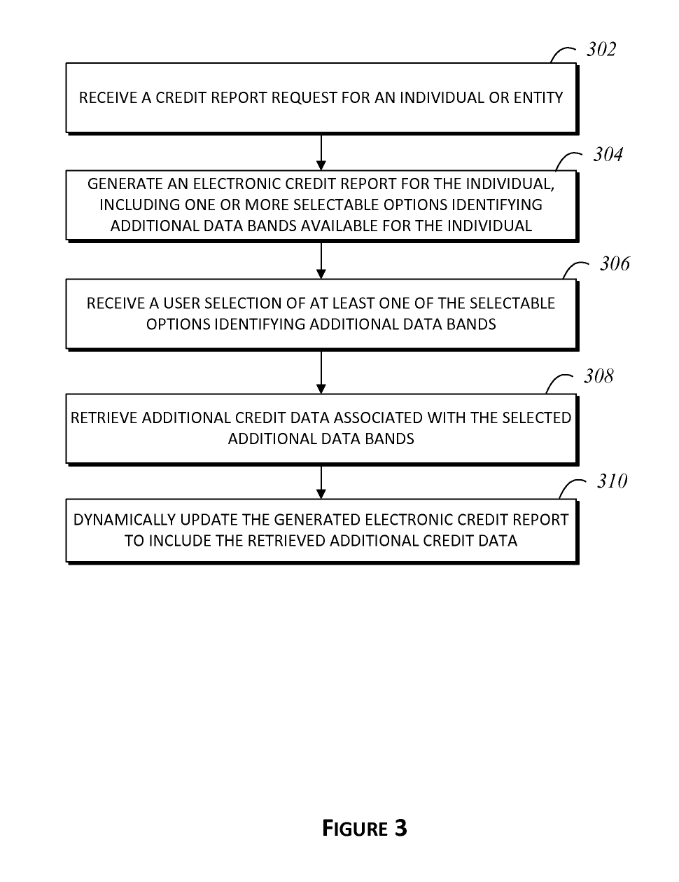

In the illustrated data flow, the user of client system 120 selects to purchase one or more additional data bands from within the provided credit report. For example, the generated credit report may have included a selectable option enabling the user to request property data associated with the individual for whom the credit report was generated, which may be associated with an additional cost to the user. In response to the user's selection, the client system 120 may send a request to the product delivery system 130 for data associated with the selected additional data band, such as property data. As illustrated, the product delivery system 130 may then retrieve the data associated with the selected data band from the master data store 110 or other data source. The product delivery system 130 may then send the updated data to the client system 120, such that the credit report is dynamically updated to include the additional data. Illustrative methods for generating and dynamically updating credit reports are discussed in more detail below with reference to FIGS. 2 and 3

In association with the delivery of the additional credit data to the client system 120, in the illustrated embodiment, the product delivery system 130 may send billing code information for the additional credit bands or other updated data to the billing system 160. The billing system 160 then determines an aggregate invoice amount based on the billing codes associated with the initial report and the billing codes associated with the additional data provided in response to the user's selection of an additional data band from the initial report. For example, the billing system 160 may determine the cost associated with each billing code for the product and the updated data based on data retrieved from billing data store 162, and may calculate a total cost based at least in part by aggregating the cost information. An invoice may then be generated by the billing system and provided to the user or other entity responsible for payment (not illustrated in the example data flow).

### Example Methods

FIG. 2 is a flow chart illustrating one embodiment of a method implemented by the product delivery system 130 for enabling a user to define a credit reporting product by selecting data bands to be included in the product. The illustrative method begins at block 202, where the product delivery system 130 generates a user interface that includes options that enable a user to select data bands to be included in a credit report. An illustrative user interface that may be generated at block 202 will be discussed below with reference to FIG. 7. The user interface may include, for example, information identifying available types of data or data bands that the user may select to include in a credit report for a given individual or entity. The data options may include, for example, consumer credit data, court records, property data, vehicle data, model scores, various premium attributes, score cards and/or other data. The product delivery system 130 may determine the list of available data types, data fields or data bands based on the types of data stored in master data store 110, relevant regulatory rules, account-level rules and/or user-level rules. According to some embodiments, certain data bands or data options may be associated with an additional monetary cost to the requesting user. The product delivery system 130 may request cost information, for display to the user, from billing system 160 or may retrieve the cost information from one or more data sources accessible to the product delivery system.

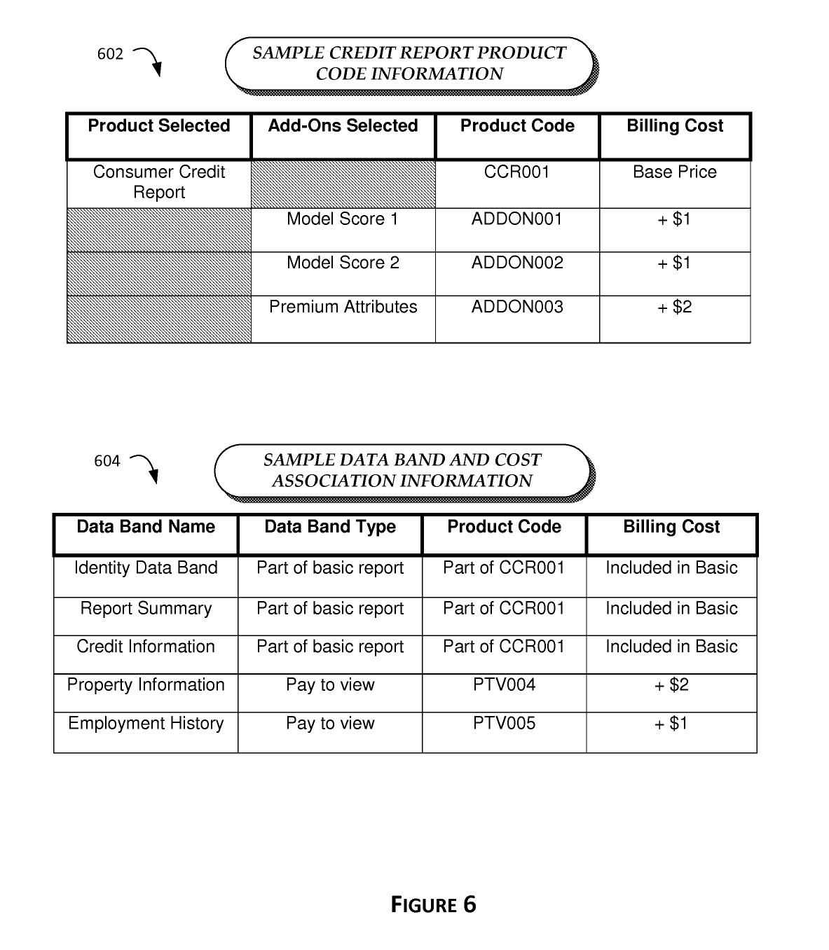

At block 204, the product delivery system 130 receives a user selection of one or more of the data bands, where the selection indicates that credit data associated with the selected data bands should be included in one or more credit reports. For example, in some embodiments, the selections may be selected by the user in order to define a credit reporting product specification that may then be used by the product delivery system to generate a number of different credit reports for different individuals and/or entities. In other embodiments, the selections may be for a one-time request for a credit report for a specific individual or entity. Once the selections have been made, the product delivery system 130 stores a credit reporting product specification based on the selected data bands, at block 206. The credit reporting product specification may be stored, for example, in product data store 142. In other embodiments, such as certain embodiments in which the user is requesting a single credit report with the selected data options, the credit reporting product specification may be stored in random access memory or other temporary memory until the report is generated and billing information is provided to the billing system 160. The stored credit reporting product specification may generally include identification of at least one data band to be included in credit reports generated based on the credit reporting product specification, and may optionally include additional format information or other information regarding the requested product. Example credit report product code information that may be stored in associated with a credit reporting product specification will be discussed below with reference to FIG. 6.

At block 208, the product delivery system 130 generates at least one credit report based on the credit reporting specification, where the credit report includes credit data associated with the selected data bands that were requested by the user and stored in the credit reporting product specification defined by the user. In some embodiments, the at least one credit report may be generated at any time after the credit reporting product specification has been generated, such as immediately after the user has made the data selections and/or in response to a later request from the same or different user. As discussed in more detail above with reference to FIG. 1B, generating the credit report may include retrieving data associated with the selected data bands from the master data store 110 and/or from one or more additional data sources. As discussed above, the product delivery system may generate scores, charts, graphs or other information to be included in the report based on the retrieved data, depending on the selected data components to be included in the report. In some embodiments, the generated credit report may be an interactive credit report that includes selectable options for further requesting additional data bands or other data types from within the generated report, as discussed below with reference to FIG. 3. In other embodiments, the generated credit report may be a static report that does not include any interactive or selectable options within the report.

FIG. 3 is a flow chart illustrating one embodiment of a method implemented by the product delivery system 130 for generating an electronic credit report and dynamically updating the generated report based on user selection of additional data bands. The illustrative method begins at block 302, where the product delivery system 130 receives a credit report request for an individual or entity. For example, the credit report request may be a request for a consumer credit report for a given individual or a commercial credit report for a business entity. For example purposes, the method will be described below with reference to a credit report for an individual. The credit report request may be for a standard credit report, a custom credit report based on the requesting user's selection of specific desired data components or data bands (as discussed above with reference to FIG. 2), or a request for a credit report having a format of a stored template or previously stored product specification.

At block 304, the product delivery system 130 generates an electronic credit report for the individual, including one or more selectable options identifying additional data bands available for the individual. The credit report may be generated using a variety of data and/or rules consideration, as previously described. In some embodiments, the credit report may include data associated with certain data bands or data groups, while providing only a selectable title or other identification information for other data bands or data groups. For example, the generated report may include the individual's residential address information in full, but may indicate that property ownership information is available for an additional fee. The data bands included in full in the generated report may include, for example, data bands that were selected by the user at the time of the initial inquiry, data bands that were identified as standard for the given product specification or template, and/or that were selected by the product delivery system for inclusion in the report based on the requesting user, a geographic region, the individual for whom the report was requested, and/or other considerations.

In some embodiments, any additional data bands for which the product delivery system 130 is capable of providing information for the individual may be included as selectable add-on data bands in the generated report. In other embodiments, the product delivery system 130 may selectively determine which additional data bands to provide as selectable add-on options based at least in part on the requesting user, a geographic region, the individual for whom the report was requested, and/or other considerations. Once the report is generated, the report may be provided to the user for viewing and/or for selection of additional data bands that the user would like to receive and have added to the report.

At block 306, the product delivery system 130 receives a user selection of at least one of the selectable options identifying additional data bands. The user selection may generally be received from the client system 120 in response to the user selecting to purchase or otherwise view one or more of the add-on data bands identified in the initially generated credit report. At block 308, in response to the user selection, the product delivery system 130 retrieves additional credit data associated with the selected additional data bands. The data may be retrieved, for example, from master data store 110. For certain types of data, such as scores and models, the product delivery system may perform calculations or other data transformations on the retrieved data.

At block 310, the product delivery system 130 dynamically updates the generated electronic credit report to include the additional credit data retrieved and/or determined at block 308. Dynamically updating the credit report may include, in some embodiments, sending the data to the client system 120, such that the electronic credit report presented by the client system 120 is updated to include the credit data. In some embodiments, the report may be updated using code embedded in the credit report and/or by an application executed by the client system. In other embodiments, the user may access the credit report via the product delivery system, such as via a browser executed by the client system displaying a page or user interface generated by the product delivery system, in which case the page or user interface may be automatically refreshed, reloaded or otherwise updated to include the additional data.

### Example Credit Reports

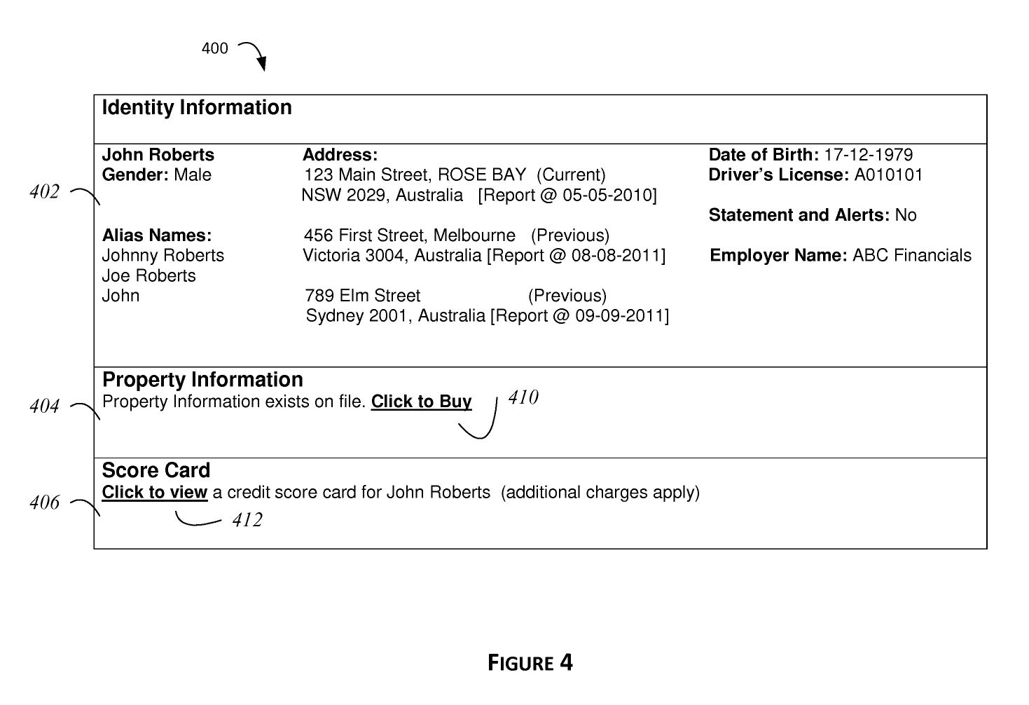

FIG. 4 is an illustrative embodiment of an electronic credit report 400, generated by the product delivery system 130, which includes selectable options for dynamically updating the credit report with additional data. The electronic credit report 400 may be displayed in a variety of ways, depending on the embodiment. For example, the credit report may have been sent to the client system 120 by the product delivery system 130 and displayed as a user interface via a browser or other application executed by the client system 120. The illustrated credit report 400 may be considered a personal credit report for an individual named John Roberts.

The credit report 400 includes full information associated with a first data band 402, including name, known addresses, alias names, date of birth, driver's license and employer name. The data band 402 may be standard for a consumer credit report, or otherwise provided by default according to the illustrated embodiment. The credit report 400 further includes information identifying two additional data bands 404 and 406, for which data associated with John Roberts is available from the product delivery system 130, but for which associated data has not been included in the credit report 400. The user may select option 410 to request and purchase property information associated with data band 404 from the product delivery system. Similarly, the user may select option 412 to request and purchase score card information associated with data band 406 from the product delivery system.

In other embodiments, additional data bands or other modularized data portions may be identified for selection by the user. For example, if the individual, John Roberts, is married to a Jane Roberts, a selectable option may be included in the credit report that enables the user to view credit data associated with Jane Roberts (not illustrated). Similarly, one or more options may enable the user to request credit data associated with one or more individuals that are members of John Roberts' household or that share an address with John Roberts. If John Roberts is a shareholder or director of a company, a selectable option may be included in the credit report that enables the user to view a commercial credit report for the company (not illustrated).

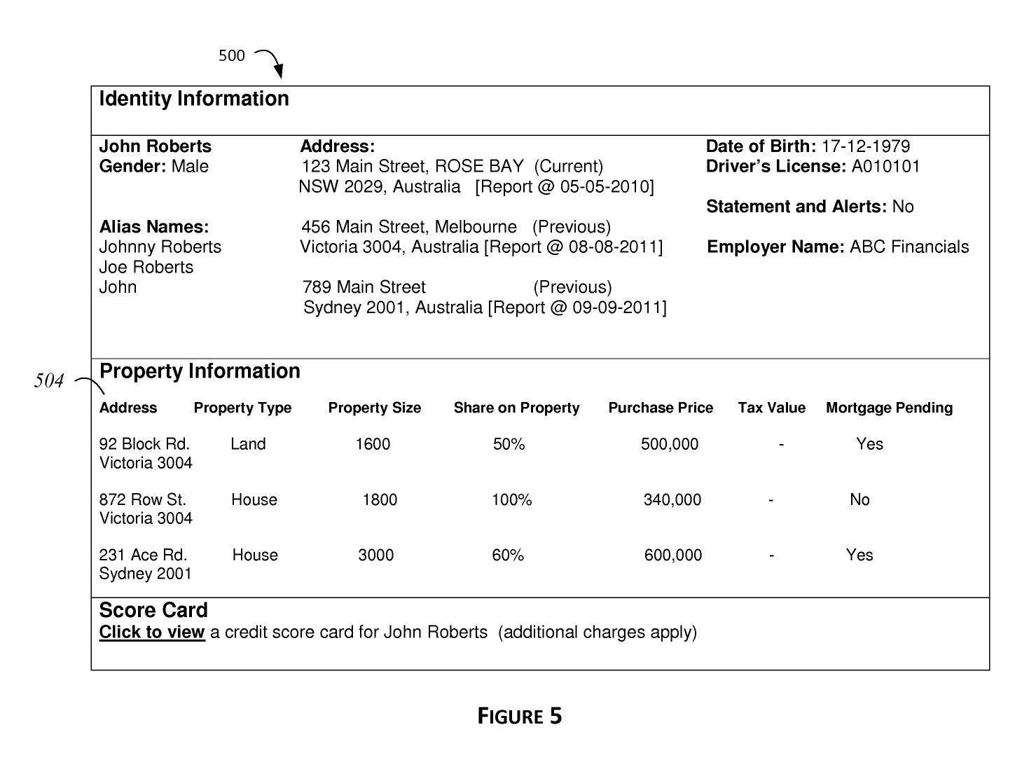

FIG. 5 is an illustrative embodiment of an electronic credit report 500, generated by the product delivery system 130, which has been dynamically updated to include data associated with an additional data band 504 selected by the user. The updated credit report 500 may be presented for display, for example, in response to the user selecting option 410 discussed with reference to FIG. 4 above. As illustrated, the credit report 500 has been dynamically updated to add property data associated with John Roberts and data band 504. The provided property data may have been retrieved by the product delivery system 130 from the master data store 110, then provided to the client system 120 for display and/or for inclusion in the previously provided credit report.

### Example Data Representations

FIG. 6 includes illustrative graphical representations 602 and 604 of credit report product code information and data band cost information. The illustrated data may be stored, for example, in billing data store 162. Illustrative table representation 602 illustrates an example of credit report product code information that may be used to identify the modular components or data bands that were included in a specific credit report, and which may be used by the billing system 160 in generating invoices. In the illustrated example, the client may have requested a consumer credit report, along with three different add-on data bands or data components (indicated as “Model Score 1,” “Model Score 2” and “Premium Attributes”), which may have been requested at the time of initial inquiry and/or added dynamically via user selections within the initially generated credit report. Each of the base product and the add-on data components are associated with a product code, which may uniquely identify the given product or data module, as well as a billing cost. According to some embodiments, the billing system 160 may aggregate the billing costs associated with each product code that appears on the report when generating an invoice for the delivered report.

Illustrative table representation 604 illustrates an example of data band and cost association information that may be retrieved from the billing data store 162 and provided to a user when offering additional data bands or upgrade offers to the user. The illustrated table 604 includes five data bands, of which three are indicated to be part of the basic credit reporting product and two of which are “pay to view” data bands that are initially unavailable to the user until purchased for an additional billing cost, as indicated.

### Example User Interface

FIG. 7 is an illustrative embodiment of a user interface 700 generated by the product delivery system 130 that enables a user to select data bands to be included in a credit reporting product. According to one embodiment, the user interface 700 may be an example of a user interface generated at block 202 of the illustrative method discussed above with reference to FIG. 2. As illustrated, the illustrated user interface 700 may be presented for display by a browser executed by the client system 120. The user interface 700 includes selectable options 702, 704, 706, 710 and 712 that enable the user to select from among the available data elements or data bands that the user would like included in a credit reporting product. The product delivery system 130 may have determined the selectable options based at least in part on the types of data stored in master data store 110, relevant regulatory rules, account-level rules and/or user-level rules. According to some embodiments, certain data bands or data options may be associated with an additional monetary cost to the requesting user, which may be displayed to the user upon the user's selection of a data band prior to purchase.

As illustrated, data band 702, basic credit report information, is marked as included in the credit report at no additional fee. Similarly, summary attributes and consumer credit account data types are illustrated in options 704 as included in the report for no additional fee. If the user would like to request that court public records data and/or property data be included in the credit report, the user may select the corresponding selectable options from options 704. In order to view additional model score options, premium attribute options and/or score card options that may be included in the report, the user may select from among options 706, 710 and 712. Once the user is satisfied with the data selections, the user may select submit inquiry option 714 to send the credit report request to the product delivery system 130, which may result in the product delivery system 130 generating a credit reporting product specification and/or generating a credit report based on the user's selections.

### Example System Architecture

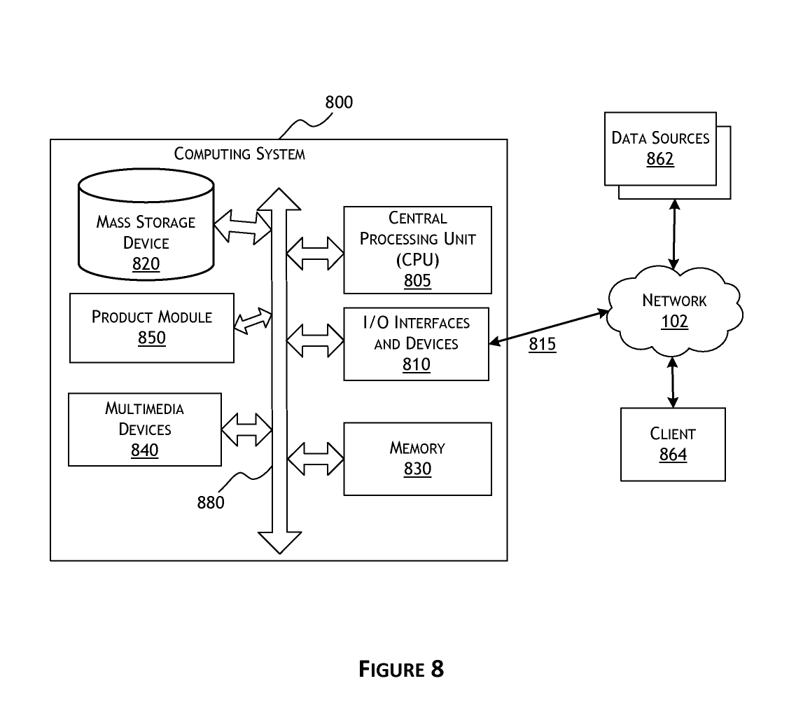

FIG. 8 is a block diagram showing an embodiment in which a computing system 800 is in communication with one or more data sources 862 and a client 864 via a network 102. The computing system 800 may be used to implement systems and methods described herein, including, but not limited to, receiving data from one or more data sources, processing the data, defining credit reporting product specifications, generating credit reporting products, updating credit reports with additional data, and/or other features described herein. For example, each of the product delivery system 130 and/or billing system 160 may include components similar to those of system 800 in FIG. 8, according to some embodiments.

The computing system 800 includes, for example, a computer that may be IBM, Macintosh, or Linux/Unix compatible or a server or workstation. In one embodiment, the computing system 800 comprises a server, desktop computer or laptop computer, for example. In one embodiment, the exemplary computing system 800 includes one or more central processing units (“CPUs”) 805, which may each include a conventional or proprietary microprocessor. The computing system 800 further includes one or more memory 830, such as random access memory (“RAM”) for temporary storage of information, one or more read only memory (“ROM”) for permanent storage of information, and one or more mass storage device 820, such as a hard drive, diskette, solid state drive, or optical media storage device. Typically, the modules of the computing system 800 are connected to the computer using a standard based bus system 880. In different embodiments, the standard based bus system could be implemented in Peripheral Component Interconnect (“PCP”), Microchannel, Small Computer System Interface (“SCSI”), Industrial Standard Architecture (“ISA”) and Extended ISA (“EISA”) architectures, for example. In addition, the functionality provided for in the components and modules of computing system 800 may be combined into fewer components and modules or further separated into additional components and modules.

The computing system 800 is generally controlled and coordinated by operating system software, such as Windows XP, Windows Vista, Windows 7, Windows Server, Unix, Linux, SunOS, Solaris, or other compatible operating systems. In Macintosh systems, the operating system may be any available operating system, such as MAC OS X. In other embodiments, the computing system 800 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 800 may include one or more commonly available input/output (I/O) devices and interfaces 810, such as a keyboard, mouse, touchpad, and printer. In one embodiment, the I/O devices and interfaces 810 include one or more display devices, such as a monitor, that allows the visual presentation of data to a user. More particularly, a display device provides for the presentation of GUIs, application software data, and multimedia presentations, for example. The computing system 800 may also include one or more multimedia devices 840, such as speakers, video cards, graphics accelerators, and microphones, for example.

In the embodiment of FIG. 8, the I/O devices and interfaces 810 provide a communication interface to various external devices. In the embodiment of FIG. 8, the computing system 800 is electronically coupled to a network 102, which comprises one or more of a LAN, WAN, and/or the Internet, for example, via a wired, wireless, or combination of wired and wireless, communication link 815. The network 102 communicates with various computing devices and/or other electronic devices via wired or wireless communication links.

According to FIG. 8, information is provided to the computing system 800 over the network 102 from one or more data sources including, for example, data sources 862. The information supplied by the various data sources may include, for example, trade data and other credit data, personal data, public record data, social network data, and so forth. In addition to the devices that are illustrated in FIG. 8, the network 102 may communicate with other data sources or other computing devices. In addition, the data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, a record-based database, and/or an unstructured database.

A client system 864 may be connected to the network 102 and used by a user to send and receive information to and from the computing system 800. The client system 864 may be a desktop computer, a mobile computer, or any other mobile device such as a mobile phone, smart phone, tablet or other similar handheld computing devices. The client system 864 and/or data sources 862 may include the same or similar components to those discussed above with reference to the computing system 800.

In the embodiment of FIG. 8, the computing system 800 also includes a product module 850 that may be stored in the mass storage device 820 as executable software codes that are executed by the CPU 805. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 8, the computing system 800 is configured to execute the product module 850 in order to implement functionality described elsewhere herein. For example, the processing module may perform methods described with reference to any of various modules described above with reference to the product delivery system 130 and/or billing system 160, depending on the embodiment.

Aspects of the disclosure, as described above, generally provide a number of advantages over traditional credit reports or other credit products. For example, a customer that has received an interactive credit report described herein, according to some embodiments, may purchase additional pieces of information using one or more selectable options provided within the report, without returning to a credit request interface and submitting a new inquiry request. Furthermore, clients can easily manage these information pieces or data bands and choose to purchase or otherwise request extra information depending on their needs, without receiving or paying for information that they don't desire or need. Aspects of the present disclosure provide product variety, which may allow a credit bureau or partner to define a report or other product at one time and then, based on customer choice or other considerations, alter the product to have a variety of configurations. The provided reports, in some embodiments, may have a consistent structure and layout, while being less complex for a viewer that is not interested in all of the data bands available. By offering newly available data and/or third-party information as an available add-on data band in a credit report, aspects of the present disclosure may accommodate third-party data and/or non-traditional data without mixing this data with other sections of a report, such as credit data traditionally included in a credit report. In some instances, providing an indication of the available additional data bands on a report may encourage customers to purchase additional information, if needed, which may provide a financial benefit to a credit bureau, partner service or data provider.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing system 800, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, one or more computing systems, data stores and/or modules described herein may be implemented using one or more open source projects or other existing platforms. For example, one or more computing systems, data stores and/or modules described herein may be implemented in part by leveraging technology associated with one or more of the following: Drools, Hibernate, JBoss, Kettle, Spring Framework, NoSQL (such as the database software implemented by MongoDB) and/or DB2 database software.

### Other Embodiments

Although the foregoing systems and methods have been described in terms of certain embodiments, other embodiments will be apparent to those of ordinary skill in the art from the disclosure herein. Additionally, other combinations, omissions, substitutions and modifications will be apparent to the skilled artisan in view of the disclosure herein. While some embodiments of the inventions have been described, these embodiments have been presented by way of example only, and are not intended to limit the scope of the inventions. Indeed, the novel methods and systems described herein may be embodied in a variety of other forms without departing from the spirit thereof. Further, the disclosure herein of any particular feature, aspect, method, property, characteristic, quality, attribute, element, or the like in connection with an embodiment can be used in all other embodiments set forth herein.

All of the processes described herein may be embodied in, and fully automated via, software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

What is claimed is:

1. A computer-implemented method for generating a customizable credit report, the computer-implemented method comprising:
as implemented by one or more computing devices configured with specific executable instructions,
generating a user interface for display that includes one or more selectable options configured to enable a user to define a credit reporting product specification that identifies at least a portion of data to be included in at least one credit report, wherein the one or more selectable options include a plurality of data bands, wherein one or more of the plurality of data bands are selectable by the user for inclusion in the at least one credit report defined by the credit reporting product specification;
receiving a user selection of at least one of the plurality of data bands, wherein the user selection indicates that credit data associated with the at least one data band should be included in credit reports generated based on the credit reporting product specification;
storing, in an electronic data store, the credit reporting product specification defined by the user; and
based at least in part on the credit reporting product specification defined by the user, generating at least one credit report for one or more individuals, wherein the at least one credit report is generated at least in part by retrieving credit data associated with the one or more individuals, wherein the retrieved credit data includes credit data associated with the at least one data band selected by the user.

2. The computer-implemented method of claim 1, wherein the one or more selectable options are determined based at least in part on a country associated with the credit reporting product specification.

3. The computer-implemented method of claim 1, wherein the one or more selectable options are determined based at least in part on the one or more individuals for which the at least one credit report is generated.

4. The computer-implemented method of claim 1, wherein the plurality of data bands comprise at least one of model score data, property data, credit card data, banking data, utility data, public agency data, employment data, insurance data, automotive data, rental data, and business data.

5. A storage medium having a computer program stored thereon for causing a suitably programmed system to process computer-program code by performing the computer implemented method of claim 1 when such program is executed on the system.

6. A credit reporting system comprising:
a credit database configured to store a plurality of records, wherein the plurality of records comprise credit data associated with each of a plurality of data bands; and
a credit report generation system configured to electronically communicate with the database, the credit report generation system comprising:
a product specification module configured to:
generate a user interface for display that includes one or more selectable options configured to enable a user to define a credit reporting product specification that identifies at least a portion of data to be included in at least one credit report, wherein the one or more selectable options include a plurality of data bands, wherein one or more of the plurality of data bands are selectable by the user for inclusion in the at least one credit report defined by the credit reporting product specification;
receive a user selection of at least one of the plurality of data bands, wherein the user selection indicates that credit data associated with the at least one data band should be included in credit reports generated based on the credit reporting product specification; and
store, in an electronic data store, the credit reporting product specification defined by the user; and
a request module configured to:
retrieve the credit reporting product specification stored by the product specification module; and
generate at least one credit report for one or more individuals, wherein the at least one credit report is generated at least in part by retrieving credit data associated with the one or more individuals from the credit database, wherein the retrieved credit data includes credit data associated with the at least one data band selected by the user.

7. The credit reporting system of claim 6, wherein the one or more selectable options are determined based at least in part on a country associated with the credit reporting product specification.

8. The credit reporting system of claim 6, wherein the one or more selectable options are determined based at least in part on the one or more individuals for which the at least one credit report is generated.

9. The credit reporting system of claim 6, wherein the plurality of data bands comprise at least one of model score data, property data, credit card data, banking data, utility data, public agency data, employment data, insurance data, automotive data, rental data, and business data.
